(19) United States
(12) Patent Application Publication
(10) Pub. No.: US 2024/0312353 A1
(43) Pub. Date: Sep. 19, 2024

(54) DISPLAY CONTROL DEVICE, DISPLAY CONTROL METHOD, AND STORAGE MEDIUM STORING DISPLAY CONTROL PROGRAM

(71) Applicant: Mitsubishi Electric Corporation, Tokyo (JP)

(72) Inventors: Jun MINAGAWA, Tokyo (JP); Shohei SHINTA, Tokyo (JP)

(73) Assignee: Mitsubishi Electric Corporation, Tokyo (JP)

(21) Appl. No.: 18/675,763

(22) Filed: May 28, 2024

Related U.S. Application Data
(63) Continuation of application No. PCT/JP2022/031491, filed on Aug. 22, 2022.

(30) Foreign Application Priority Data
Dec. 28, 2021 (WO) PCT/JP2021/048875

(51) Int. Cl. G08G 5/04; G08G 5/00; G08G 5/06

(52) U.S. Cl. CPC G08G 5/045; G08G 5/0021; G08G 5/0043; G08G 5/0091; G08G 5/065

(57) ABSTRACT

A display control device acquires a first predicted trajectory of a selected mobile object and a plurality of second predicted trajectories, estimates an abnormal approach mobile object as a mobile object having a period in which a distance from the selected mobile object is less than or equal to a predetermined reference value out of the plurality of relevant mobile objects and estimates the position of the abnormal approach mobile object in the abnormal approach period, and makes a display device display a two-dimensional coordinate system formed by a first coordinate axis representing a position in the first predicted trajectory by a distance from a start point and a second coordinate axis representing a time and a line indicating the first predicted trajectory and to make the display device display an enhanced display component that indicates the position of the abnormal approach mobile object in the abnormal approach period.

### CROSS-REFERENCE TO RELATED APPLICATION

This application is a continuation application of International Application No. PCT/JP2022/031491 having an international filing date of Aug. 22, 2022 and claiming priority based on PCT/JP2021/048875 with an international filing date of Dec. 28, 2021.

### BACKGROUND OF THE INVENTION

### 1. Field of the Invention

The present disclosure relates to a display control device, a display control method, and a display control program.

### 2. Description of the Related Art

There has been proposed a control information display system including a display means that displays a travel route of a mobile object (e.g., aircraft, vehicle or the like) traveling on the ground in an airport on a two-dimensional plane formed by a coordinate axis representing the time and a coordinate axis representing the position. See Patent Reference 1, for example. A situation where the need for paying attention arises in a selected mobile object is a situation where a different mobile object shares a part of the course of the selected mobile object. The sharing of the course occurs in cases where a taxiway forming the course of the selected mobile object and a taxiway forming the course of the different mobile object intersect with each other at an intersection and in cases where the selected mobile object and the different mobile object travel in the same direction or in opposite directions on a common taxiway. Therefore, in the system of the Patent Reference 1, a two-dimensional plane indicating a traveling condition of the selected mobile object and another two-dimensional plane indicating a traveling condition of the different mobile object are displayed so as to intersect with each other, i.e., the traveling conditions of the two mobile objects are displayed three-dimensionally.

Patent Reference 1: Japanese Patent Application Publication No. 2006-350445 (see claims 1 and 2, paragraphs 0038 and 0039, and FIG. 4 to FIG. 6, for example)

However, in the case of the display mode three-dimensionally displaying the traveling conditions of the two mobile objects, there is a problem in that it is difficult for an air traffic controller viewing the display means to predict an abnormal approach between mobile objects.

### SUMMARY OF THE INVENTION

An object of the present disclosure is to provide a display control device, a display control method and a display control program that enable a display in a display mode facilitating the prediction of an abnormal approach between mobile objects.

A display control device in the present disclosure is a device in a control system for transmitting commands to a plurality of mobile objects traveling on a plurality of tracks. The display control device includes the display control device comprising processing circuitry to acquire track structure data indicating structure of the plurality of tracks; to acquire control information from a management device that manages the control information including positions and operation schedules of the plurality of mobile objects; to estimate predicted trajectories indicating travel routes of the plurality of mobile objects based on the track structure data and the control information; to acquire a first predicted trajectory indicating a travel route of a mobile object selected as a monitoring target among the plurality of mobile objects and a plurality of second predicted trajectories indicating travel routes of a plurality of relevant mobile objects being mobile objects other than the selected mobile object from the predicted trajectories; to estimate an abnormal approach mobile object as a mobile object having a period in which a distance from the selected mobile object is less than or equal to a predetermined reference value out of the plurality of relevant mobile objects and to estimate the position of the abnormal approach mobile object in the abnormal approach period based on the track structure data, the first predicted trajectory, and the plurality of second predicted trajectories; and to make a display device display a two-dimensional coordinate system formed by a first coordinate axis representing positions from a start point to an end point of the first predicted trajectory by distances from the start point and a second coordinate axis representing a time and a line indicating the first predicted trajectory in the two-dimensional coordinate system and to make the display device display an enhanced display component that indicates the position of the abnormal approach mobile object in the abnormal approach period in the two-dimensional coordinate system.

A display control method in the present disclosure is a method to be executed by a display control device in a control system that transmits commands to a plurality of mobile objects traveling on a plurality of tracks. The display control method includes acquiring track structure data indicating structure of the plurality of tracks; acquiring control information from a management device that manages the control information including positions and operation schedules of the plurality of mobile objects; estimating predicted trajectories indicating travel routes of the plurality of mobile objects based on the track structure data and the control information; acquiring a first predicted trajectory indicating a travel route of a mobile object selected as a monitoring target among the plurality of mobile objects and a plurality of second predicted trajectories indicating travel routes of a plurality of relevant mobile objects being mobile objects other than the selected mobile object from the predicted trajectories; estimating an abnormal approach mobile object as a mobile object having a period in which a distance from the selected mobile object is less than or equal to a predetermined reference value out of the plurality of relevant mobile objects and estimating the position of the abnormal approach mobile object in the abnormal approach period based on the track structure data, the first predicted trajectory, and the plurality of second predicted trajectories; and making a display device display a two-dimensional coordinate system formed by a first coordinate axis representing positions from a start point to an end point of the first predicted trajectory by distances from the start point and a second coordinate axis representing a time and a line indicating the first predicted trajectory in the two-dimensional coordinate system and making the display device display an enhanced display component that indicates the position of the abnormal approach mobile object in the abnormal approach period in the two-dimensional coordinate system.

According to the present disclosure, it is possible to make a display device present a display in a display mode facilitating the prediction of an abnormal approach between mobile objects.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a functional block diagram schematically showing the configuration of a display control device and a control system according to a first embodiment;

FIG. 2 is a diagram showing an example of the hardware configuration of the display control device according to the first embodiment;

FIG. 3 is a flowchart showing the operation of the display control device according to the first embodiment;

FIG. 4 is a plan view showing an example of runways and taxiways as tracks in an airport;

FIG. 5A is a plan view showing an example of a predicted trajectory of a selected aircraft, and FIG. 5B is a diagram showing an example of the predicted trajectory of the selected aircraft in a two-dimensional coordinate system formed by a position coordinate axis and a time coordinate axis;

FIG. 6A is a plan view showing an example of a predicted trajectory of a relevant aircraft, and FIG. 6B is a diagram showing an example of the predicted trajectory of the relevant aircraft in the two-dimensional coordinate system formed by a position coordinate axis and a time coordinate axis;

FIG. 7A is a plan view showing an example of predicted trajectories in a situation where the selected aircraft and an aircraft relevant to the selected aircraft travel in directions of approaching each other on the same taxiway, and FIG. 7B is a diagram showing an example of indicating the position of the abnormal approach between the selected aircraft and the aircraft relevant to the selected aircraft in the two-dimensional coordinate system;

FIG. 8A is a plan view showing an example in which the selected aircraft and the aircraft relevant to the selected aircraft start traveling in the directions of approaching each other on the same taxiway, and FIG. 8B is a diagram showing a display example of a display device at the time of the occurrence of head-on approach in FIG. 8A;

FIG. 9A is a plan view showing an abnormal approach situation as a situation where the selected aircraft and the aircraft relevant to the selected aircraft travels in the directions of approaching each other on the same taxiway and the relevant aircraft enters an abnormal approach range of the selected aircraft, and FIG. 9B is a diagram showing a display example of the display device at the time of the occurrence of the abnormal approach situation in FIG. 9A;

FIG. 10A is a plan view showing an example of predicted trajectories of the selected aircraft and the aircraft relevant to the selected aircraft, and FIG. 10B is a plan view showing an example of occurrence of an abnormal approach (danger of collision in this example) of the selected aircraft and the relevant aircraft at an intersection;

FIG. 11 is a diagram showing a display example at the time of the occurrence of the abnormal approach in FIG. 10B (danger of collision at the intersection in this example);

FIG. 12A is a plan view showing an example of a predicted trajectory of the selected aircraft and an example of a predicted trajectory of the relevant aircraft, and FIG. 12B is a plan view showing an example in which travel in the same direction on the same taxiway;

FIG. 13 is a diagram showing a display example at the time of the occurrence of the abnormal approach in FIG. 12B (danger of rear-end collision in this example);

FIG. 14A is a plan view showing an example of a predicted trajectory of a selected aircraft and an example of a predicted trajectory of a relevant aircraft, and FIG. 14B is a plan view showing an example in which the selected aircraft and the aircraft relevant to the selected aircraft travel in the same direction on the same taxiway;

FIG. 15 is a diagram showing a display example at the time of the occurrence of the abnormal approach in FIG. 14B (danger of rear-end collision in this example);

FIG. 16 is a flowchart showing a drawing process of the display control device according to the first embodiment;

FIG. 17 is a functional block diagram schematically showing the configuration of a display control device and a control system according to a second embodiment;

FIG. 18 is a flowchart showing the operation of the display control device according to the second embodiment;

FIG. 19 is a flowchart showing a drawing process of the display control device according to the second embodiment;

FIG. 20 is a diagram showing a display example of enhanced display components at the time of the occurrence of the abnormal approach;

FIG. 21A is a plan view showing an example in which the selected aircraft (aircraft at a high priority level) and the aircraft relevant to the selected aircraft start traveling in the directions of approaching each other on the same taxiway, and FIG. 21B is a diagram showing a display example of the display device at the time of the occurrence of the situation in FIG. 21A;

FIG. 22 is a functional block diagram schematically showing the configuration of a display control device and a control system according to a third embodiment;

FIG. 23A is a plan view showing an example of a situation immediately before a selected aircraft crosses a runway (i.e., a case where there is a no-entry region in front), and FIG. 23B is a diagram showing a display example of the display device at the time of the occurrence of the situation in FIG. 23A;

FIG. 24A is a plan view showing an example of a situation immediately before the selected aircraft crosses the runway (i.e., a case where there is no no-entry region in front), and FIG. 24B is a diagram showing a display example of the display device at the time of the occurrence of the situation in FIG. 24A;

FIG. 25A is a plan view showing an example of a situation immediately before the selected aircraft crosses the runway, and FIG. 25B is a diagram showing a display example of the display device at the time of the occurrence of the situation in FIG. 25A;

FIG. 26 is a functional block diagram schematically showing the configuration of a display control device and a control system according to a fourth embodiment; and

FIG. 27A is a diagram showing an example in which the selected aircraft crosses a runway (i.e., a case where there is the no-entry region in front), and FIG. 27B is a diagram showing the operation of a trajectory automatic setting unit at the time of the occurrence of the situation in FIG. 27A.

### DETAILED DESCRIPTION OF THE INVENTION

A display control device, a display control method and a display control program according to each embodiment will be described below with reference to the drawings. The following embodiments are just examples and it is possible to appropriately combine embodiments and appropriately modify each embodiment.

### First Embodiment

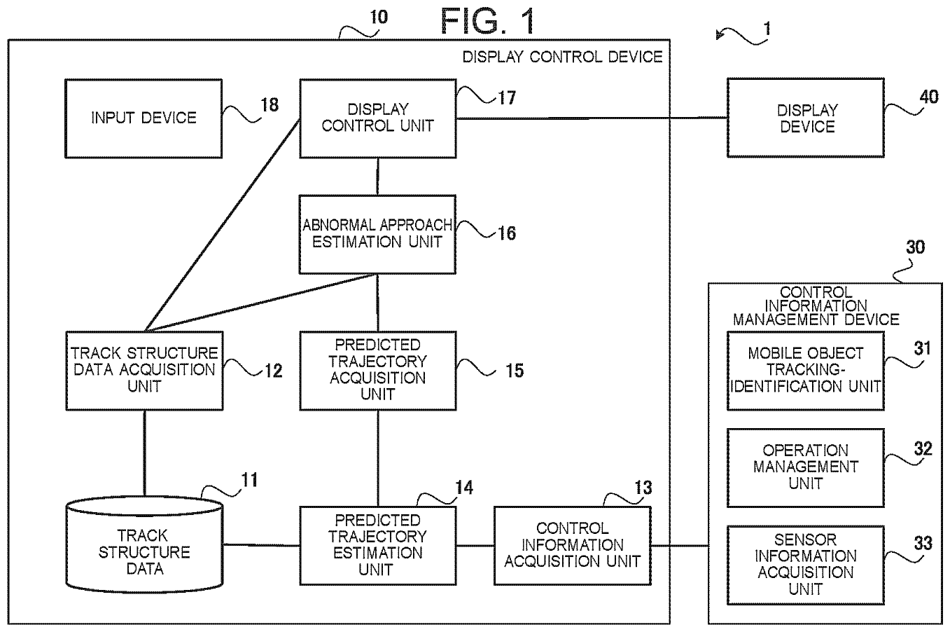

FIG. 1 is a functional block diagram schematically showing the configuration of a display control device 10 and a control system 1 according to a first embodiment. The display control device 10 is a device capable of executing a display control method according to the first embodiment. The display control device 10 is, for example, a computer executing a display control program according to the first embodiment.

The display control device 10 is a part of the control system (i.e., air traffic control system) 1 that transmits commands to a plurality of mobile objects traveling on a plurality of tracks on the ground. The control system 1 includes a control information management device 30 as a management device and a display device 40 such as a liquid crystal monitor that displays images. The control system 1 is, for example, an airport control system that transmits commands to a plurality of aircraft as a plurality of mobile objects. The plurality of tracks are runways and taxiways in the airport, for example. In general, the control system of the airport handles flying aircraft and taxiing aircraft as targets of the control (i.e., air traffic control). However, the mobile objects to which the control system 1 in the present disclosure transmits commands are mobile objects traveling on the ground (including aircraft with the wheels not in contact with the runway and flying immediately above the runway at the time of landing or takeoff). The mobile object is not limited to an aircraft but can also be a vehicle such as an automobile. Further, the mobile objects may include both of aircraft and vehicles.

The control information management device 30 includes a mobile object tracking-identification unit 31, an operation management unit 32 and a sensor information acquisition unit 33. The mobile object tracking-identification unit 31 keeps track of the positions of the plurality of mobile objects and identifies each of the plurality of mobile objects. The operation management unit 32 manages operation management information including operation times of the plurality of mobile objects and an operation route of each of the plurality of mobile objects from a travel starting point (i.e., start point) to a destination (i.e., end point). The sensor information acquisition unit 33 receives sensing information regarding a mobile object from a sensor sensing the mobile object.

The display control device 10 includes a track structure data acquisition unit 12, a control information acquisition unit 13, a predicted trajectory estimation unit 14, a predicted trajectory acquisition unit 15, an abnormal approach estimation unit 16 and a display control unit 17.

The track structure data acquisition unit 12 acquires track structure data indicating the structure of the plurality of tracks from a storage device 11. The track structure data is, for example, map data of the tracks. Specifically, the track structure data acquisition unit 12 reads out the structure of the tracks (e.g., length of each taxiway and the like) stored in the storage device 11 such as a nonvolatile memory and gives the structure to the abnormal approach estimation unit 16. While the storage device 11 is shown as a part of the display control device 10 in FIG. 1, the storage device 11 can also be an external storage device capable of communicating with the display control device 10.

The control information acquisition unit 13 acquires control information (e.g., air traffic control information) from the control information management device 30 that manages the control information including the positions and operation schedules of the plurality of mobile objects. Specifically, the control information acquisition unit 13 acquires present positions of the mobile objects, the operation management information, and so forth managed by the control information management device 30.

The predicted trajectory estimation unit 14 estimates predicted trajectories (e.g., scheduled loci of mobile objects traveling on the ground) indicating travel routes of the plurality of mobile objects based on the track structure data and the control information. Specifically, the predicted trajectory estimation unit 14 estimates the predicted trajectories and the present positions of the mobile objects based on the present positions of the mobile objects and the operation management information acquired from the control information acquisition unit 13. The predicted trajectories also include loci of aircraft with the wheels not in contact with the runway and flying immediately above the runway at the time of landing or takeoff.

The predicted trajectory acquisition unit 15 acquires a first predicted trajectory indicating the travel route of a mobile object selected as a monitoring target (referred to also as a “selected mobile object”) among the plurality of mobile objects and a plurality of second predicted trajectories indicating the travel routes of a plurality of relevant mobile objects being mobile objects other than the selected mobile object from the estimated predicted trajectories. Specifically, the predicted trajectory acquisition unit 15 reads out the predicted trajectories (predicted loci) of the mobile objects calculated by the predicted trajectory estimation unit 14 and gives the predicted trajectories to the abnormal approach estimation unit 16.

The abnormal approach estimation unit 16 estimates an abnormal approach mobile object as a mobile object having a period in which the distance from the selected mobile object is less than or equal to a predetermined reference value (i.e., threshold value) out of the plurality of relevant mobile objects and estimates the position of the mobile object (referred to also as the “abnormal approach mobile object”) in the abnormal approach period based on the track structure data, the first predicted trajectory and the plurality of second predicted trajectories. Specifically, the abnormal approach estimation unit 16 refers to the selected mobile object acquired from an input device 18 and estimates an abnormal approach region (e.g., near collision region) of the mobile object. The estimated abnormal approach region is given to the display control unit 17 and thereby displayed as an enhanced display component in superimposition on a diagram. The abnormal approach region is calculated based on the structure of the track of the mobile object (e.g., the length of the taxiway or the like) acquired from the track structure data acquisition unit 12 and the predicted trajectory of the mobile object acquired from the predicted trajectory acquisition unit 15.

The abnormal approach estimation unit 16 may acquire information regarding a visibility range in atmospheric air (maximum distance at which the shape of a target can be recognized with the naked eye) at a plurality of tracks (e.g., measurement values of visibility meters) from the control information management device 30 and modify the predetermined reference value based on the acquired visibility range. For example, the reference value can be adjusted properly by increasing the reference value with the decrease in the visibility range due to the atmospheric air condition such as fog, rain and snow. Further, the abnormal approach estimation unit 16 may acquire information regarding wind directions and wind speeds at a plurality of tracks (e.g., measurement values of anemoscopes and anemometers) from the control information management device 30 and modify the predetermined reference value based on the wind directions and the wind speeds. For example, the reference value can be adjusted properly by increasing the reference value when the wind direction is a following wind direction with the increase in the wind speed. Furthermore, the abnormal approach estimation unit 16 may acquire information regarding the size of the selected mobile object and the size of the abnormal approach mobile object (e.g., data regarding the aircraft, mobile object size information and inter-mobile object distance information obtained by analysis of camera images, and so forth) from the control information management device 30 and modify the predetermined reference value based on the size of the selected mobile object and the size of the abnormal approach mobile object. For example, a braking distance as the distance necessary for stopping increases with the increase in the size (i.e., with the increase in the weight) of the selected mobile object and with the increase in the size of the abnormal approach mobile object, and thus the reference value can be adjusted properly by increasing the reference value with the increase in the size of the selected mobile object and with the increase in the size of the abnormal approach mobile object. This is because a larger mobile object has greater weight and its braking distance as the distance necessary for stopping is longer.

The display control unit 17 makes the display device 40 display a two-dimensional coordinate system, formed by a first coordinate axis representing positions from a start point to an end point of the first predicted trajectory by distances from the start point (the unit is [m], for example, and the distance can also be the distance from the end point) and a second coordinate axis representing the time (e.g., elapsed time from a reference time to, and the unit is [s], for example), and a line indicating the first predicted trajectory in the two-dimensional coordinate system. Specifically, in this embodiment, the display control unit 17 makes the display device 40 display the two-dimensional coordinate system formed by the first coordinate axis representing the positions from the start point to the end point of the first predicted trajectory by distances from the start point or the end point and the second coordinate axis representing the time, the line indicating the first predicted trajectory in the two-dimensional coordinate system, and the abnormal approach region indicating ranges of the time and the position of an abnormal approach in the abnormal approach period. The two-dimensional coordinate system and the line indicating the predicted trajectory are referred to also as a diagram. The diagram is displayed by referring to selection information from the air traffic controller (i.e., user of the system) inputted through the input device 18. Further, the display control unit 17 makes the display device 40 display an enhanced display component indicating the position of the abnormal approach mobile object in the abnormal approach period in the two-dimensional coordinate system. The enhanced display component is displayed in superimposition on the diagram. Specifically, the display control unit 17 makes the display device 40 display figures representing the mobile objects, a map, the enhanced display component, and so forth. The enhanced display component is, for example, a display component obtained by filling in a predetermined figure (e.g., circle, quadrangle, star or the like) with a predetermined color (e.g., yellow, orange, red or the like). The enhanced display component can also be a display component using variation in the luminance by blinking, variation in the color, variation in the shape, or a combination of two or more of these variations.

The input device 18 is an operation input unit that receives inputs from the air traffic controller. The input device 18 is, for example, a keyboard, a mouse, a touch panel, a microphone for audio input, or the like. The input from the air traffic controller is, for example, an operation of selecting the trajectory of a mobile object to be displayed or the like. The input device 18 gives the input from the air traffic controller to the display control unit 17 as input data.

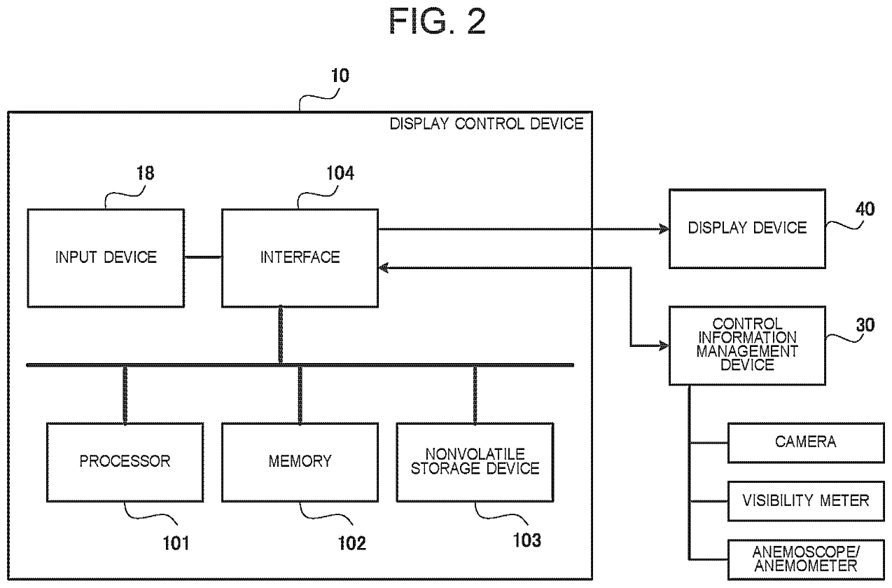

FIG. 2 is a diagram showing an example of the hardware configuration of the display control device 10. As shown in FIG. 2, the display control device 10 includes a processor 101 such as a CPU (Central Processing Unit), a memory 102 as a volatile storage device, a nonvolatile storage device 103 such as a hard disk drive (HDD) or a solid state drive (SSD), and an interface 104. The memory 102 is a semiconductor memory such as a RAM (Random Access Memory), for example. The nonvolatile storage device 103 can be the same device as the storage device 11 shown in FIG. 1.

Functions of the display control device 10 are implemented by processing circuitry, for example. The processing circuitry can be either dedicated hardware or the processor 101 executing a program stored in the memory 102. The processor 101 can be any one of a processing device, an arithmetic device, a microprocessor, a microcomputer and a DSP (Digital Signal Processor). The memory 102 may be a storage device such as a non-transitory computer-readable storage medium storing the program.

In the case where the processing circuitry is dedicated hardware, the processing circuitry is, for example, a single circuit, a combined circuit, a programmed processor, a parallelly programmed processor, an ASIC (Application Specific Integrated Circuit), an FPGA (Field-Programmable Gate Array) or a combination of some of these circuits.

In the case where the processing circuitry is the processor 101, the display control program to be executed by the display control device 10 is implemented by software, firmware or a combination of software and firmware. The display control program is installed in the display control device 10 via a network or from a record medium. The software and the firmware are described as programs and stored in the memory 102. The processor 101 is capable of implementing the functions of the units shown in FIG. 1 by reading out and executing the display control program stored in the memory 102.

Incidentally, it is also possible to implement part of the display control device 10 by dedicated hardware and part of the display control device 10 by software or firmware. As above, the processing circuitry is capable of implementing the above-described functions by hardware, software, firmware or a combination of some of these means.

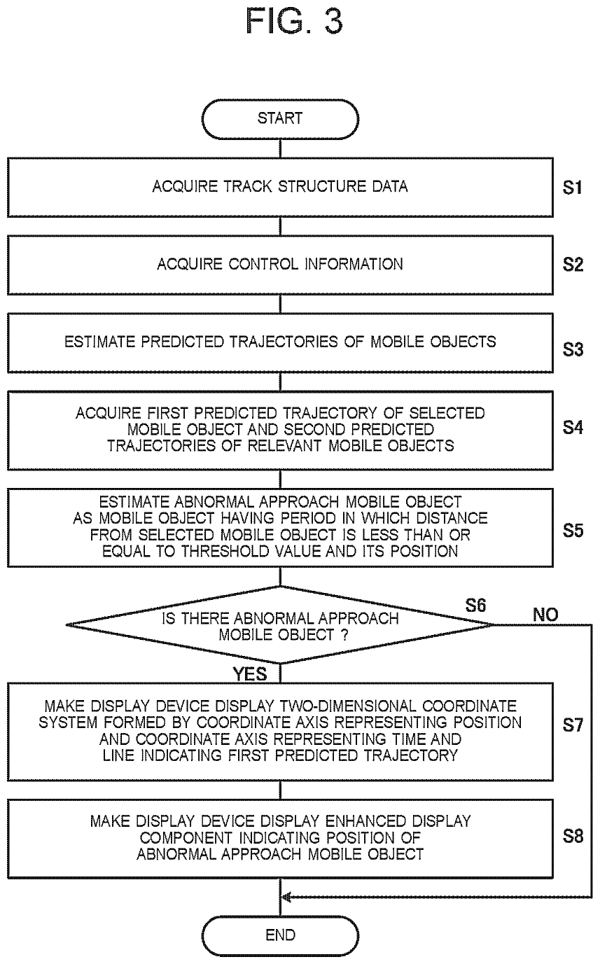

FIG. 3 is a flowchart showing the operation of the display control device 10. FIG. 3 shows the display control method according to the first embodiment executed by the display control device 10 of the control system 1 transmitting commands to a plurality of mobile objects traveling on a plurality of tracks.

First, the display control device 10 acquires the track structure data indicating the structure of the plurality of tracks (step S1) and acquires the control information from the control information management device 30 that manages the control information including the positions and the operation schedules of the plurality of mobile objects (step S2). The steps S1 and S2 may also be executed in reverse order or executed in parallel.

The display control device 10 estimates the predicted trajectories indicating the travel routes of the plurality of mobile objects based on the track structure data and the control information (step S3).

The display control device 10 acquires the first predicted trajectory indicating the travel route of the mobile object selected as the monitoring target among the plurality of mobile objects and the plurality of second predicted trajectories indicating the travel routes of the plurality of relevant mobile objects being mobile objects other than the selected mobile object from the estimated predicted trajectories (step S4).

The display control device 10 estimates the abnormal approach mobile object as a mobile object having the period in which the distance from the selected mobile object is less than or equal to the predetermined reference value out of the plurality of relevant mobile objects and estimates the position of the abnormal approach mobile object in the abnormal approach period based on the track structure data, the first predicted trajectory and the plurality of second predicted trajectories (step S5).

When there is an abnormal approach mobile object (YES in step S6), the display control device 10 makes the display device 40 display the two-dimensional coordinate system, formed by the first coordinate axis representing the positions from the start point to the end point of the first predicted trajectory by distances from the start point (e.g., horizontal axis) and the second coordinate axis representing the time (e.g., vertical axis), and the line (e.g., straight line or curved line) indicating the first predicted trajectory in the two-dimensional coordinate system (step S7), and makes the display device 40 display the enhanced display component indicating the position of the abnormal approach mobile object in the abnormal approach period in the two-dimensional coordinate system (step S8). When there is no abnormal approach mobile object (NO in the step S6), the display control device 10 ends the execution of the display control method according to the first embodiment.

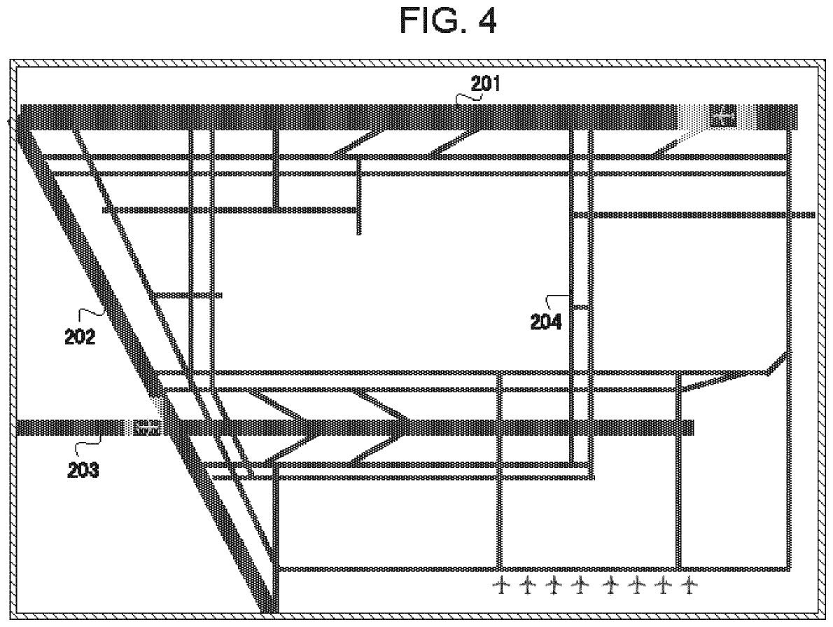

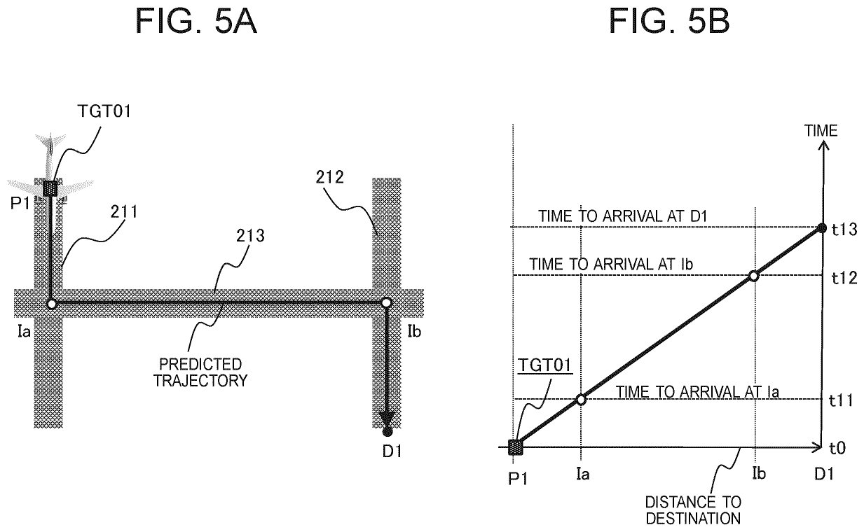

FIG. 4 is a plan view showing an example of runways 201 to 203 and taxiways 204 as the tracks in the airport. The runways 201 to 203 are used for takeoff and landing of aircraft. The taxiway 204 is a passage for taxiing of aircraft as the mobile objects and is mainly used for traveling between a hardstand and a runway. FIG. 5A is a plan view showing an example of the predicted trajectory of a selected aircraft TGT01. FIG. 5B is a diagram showing an example of the predicted trajectory of the selected aircraft TGT01 in the two-dimensional coordinate system formed by the position coordinate axis and the time coordinate axis. FIG. 5A shows a taxiway 211, a taxiway 212 in parallel with the taxiway 211, and a taxiway 213 intersecting with both of the taxiways 211 and 212. A reference character Ia is assigned to an intersection of the taxiway 211 and the taxiway 213. A reference character Ib is assigned to an intersection of the taxiway 212 and the taxiway 213. FIG. 5A shows an example in which the aircraft TGT01 taxis from a start point P1 as a starting position of the taxiing to an end point D1 as a destination by successively passing through the intersections Ia and Ib. In FIG. 5B, the predicted trajectory (predicted locus) in the example in which the aircraft TGT01 taxis from the start point P1 as the starting position of the taxiing (time t0) to the end point D1 as the destination (time t13) by successively passing through the intersections Ia and Ib (time t11, time t12) is shown in the two-dimensional coordinate system as a straight line. The times t11, t12 and t13 represent elapsed times from the time to. The predicted trajectory is not limited to a straight line but can also be a curved line, a combination of a curved line and a straight line, a combination of a plurality of straight lines differing in the gradient, or the like. The predicted trajectory and a mark (quadrangular mark in this example) indicating the position of the aircraft TGT01 and displayed in superimposition on the predicted trajectory are shown in FIG. 5B.

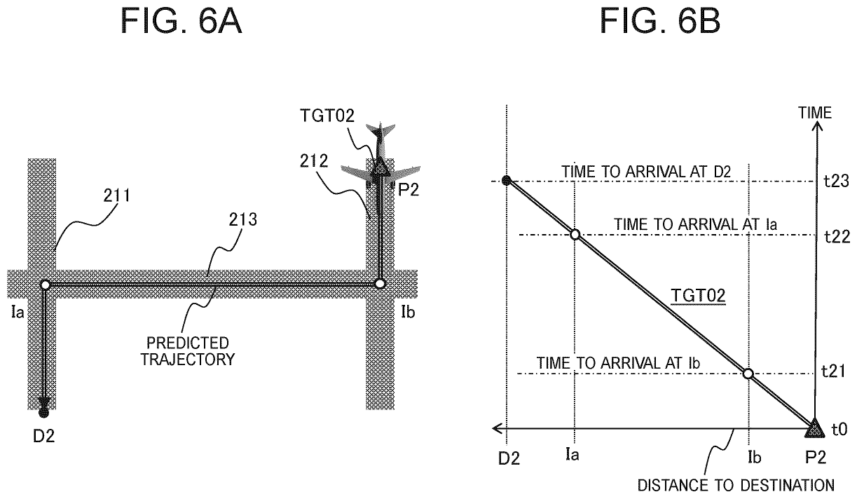

FIG. 6A is a plan view showing an example of the predicted trajectory of an aircraft TGT02 relevant to the selected aircraft TGT01. FIG. 6B is a diagram showing an example of the predicted trajectory of the aircraft TGT02 in the two-dimensional coordinate system formed by the position coordinate axis and the time coordinate axis. FIG. 6A shows an example in which the aircraft TGT02 taxis from a start point P2 as a starting position of the taxiing to an end point D2 as a destination by successively passing through the intersections Ib and Ia. In FIG. 6B, the example in which the aircraft TGT02 taxis from the start point P2 as the starting position of the taxiing (time t0) to the end point D2 as the destination (time t23) by successively passing through the intersections Ib and Ia (time t21, time t22) is shown in the two-dimensional coordinate system as a straight line. The times t21, t22 and t23 represent elapsed times from the time to. The predicted trajectory is not limited to a straight line but can also be a curved line, a combination of a curved line and a straight line, a combination of a plurality of straight lines differing in the gradient, or the like. The predicted trajectory and a mark (triangular mark in this example) indicating the position of the aircraft TGT02 and displayed in superimposition on the predicted trajectory are shown in FIG. 6B.

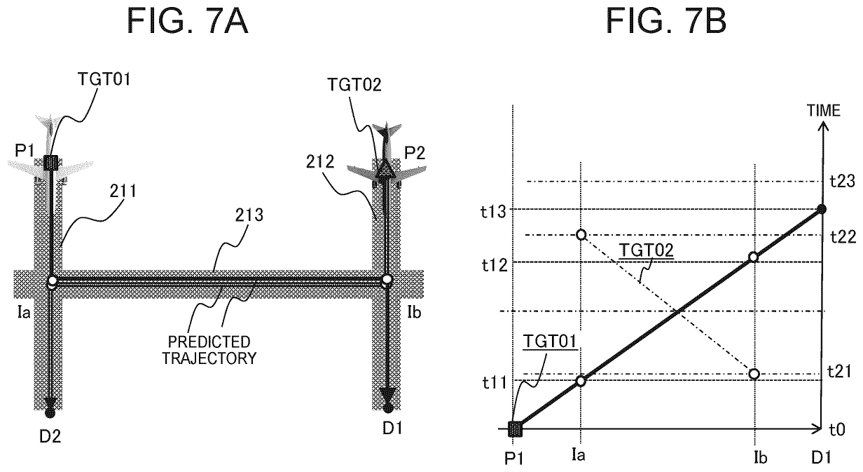

FIG. 7A is a plan view showing an example of the predicted trajectories in a situation where the selected aircraft TGT01 and the relevant aircraft TGT02 travel in directions of approaching each other on the same taxiway 213 (when head-on approach occurs, namely, in a situation where a head-on collision can occur). FIG. 7B is a diagram showing an example of indicating the position of the abnormal approach between the selected aircraft TGT01 and the relevant aircraft TGT02 in the two-dimensional coordinate system.

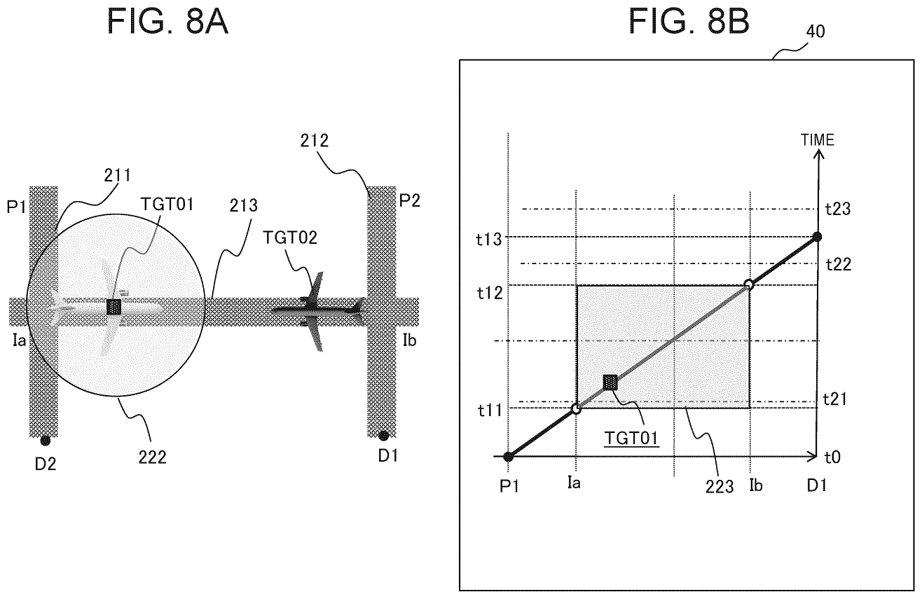

FIG. 8A is a plan view showing an example in which the selected aircraft TGT01 and the aircraft TGT02 relevant to the selected aircraft TGT01 start traveling in the directions of approaching each other on the same taxiway 213. FIG. 8B is a diagram showing a display example of the display device 40 at the time of the occurrence of the head-on approach in FIG. 8A. As shown in FIG. 8B, when there are two aircraft TGT01 and TGT02 that start traveling in the directions of approaching each other on the same taxiway 213, a head-on region 223 as a region in which the head-on collision can occur (region including a section between the intersections Ia and Ib in the taxiway 213) is designated as an enhanced region to be filled in with a color representing the head-on region 223 (e.g., predetermined color). The enhanced region is a region that is displayed in enhanced display so as to draw attention of an observer. The method of displaying the enhanced region is not limited to the filling in with color but can also be variation in the color, variation in the luminance, variation in the pattern, a combination of two or more of these methods, or the like.

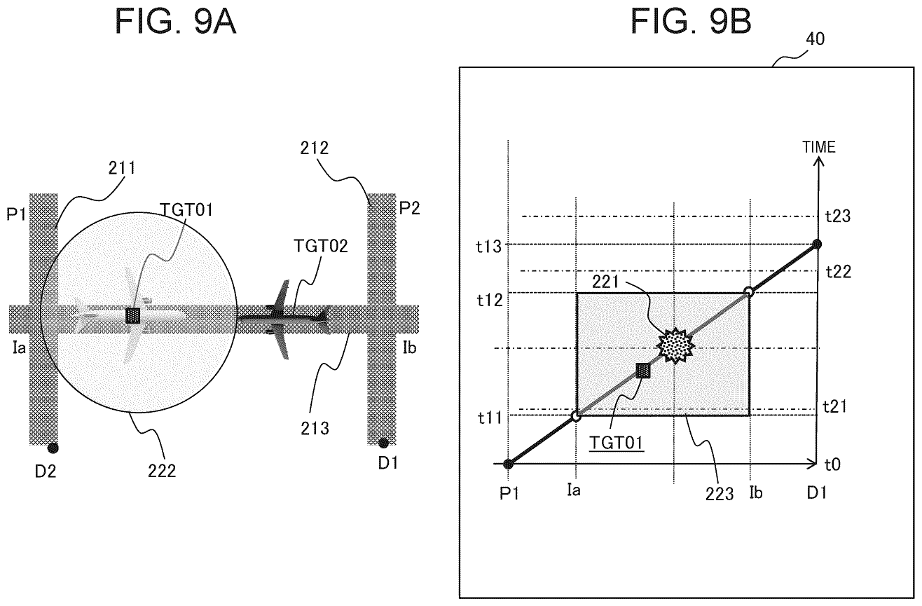

FIG. 9A is a plan view showing an abnormal approach situation as a situation where the selected aircraft TGT01 and the aircraft TGT02 relevant to the selected aircraft TGT01 traveled in the directions of approaching each other on the same taxiway 213 and the aircraft TGT02 has entered an abnormal approach range 222 of the aircraft TGT01. FIG. 9B is a diagram showing a display example of the display device 40 at the time of the occurrence of the abnormal approach situation in FIG. 9A. As shown in FIG. 9B, when there are two aircraft traveling in the directions of approaching each other on the same taxiway 213 and the aircraft TGT02 has entered the abnormal approach range 222 of the aircraft TGT01, the display control device 10 makes the display device 40 display an enhanced display component 221 at the position of the aircraft TGT02 relevant to the selected aircraft TGT01 at the time of the occurrence of the abnormal approach in addition to the display of the head-on region 223. FIG. 9B corresponds to the state of the step S8 in FIG. 3.

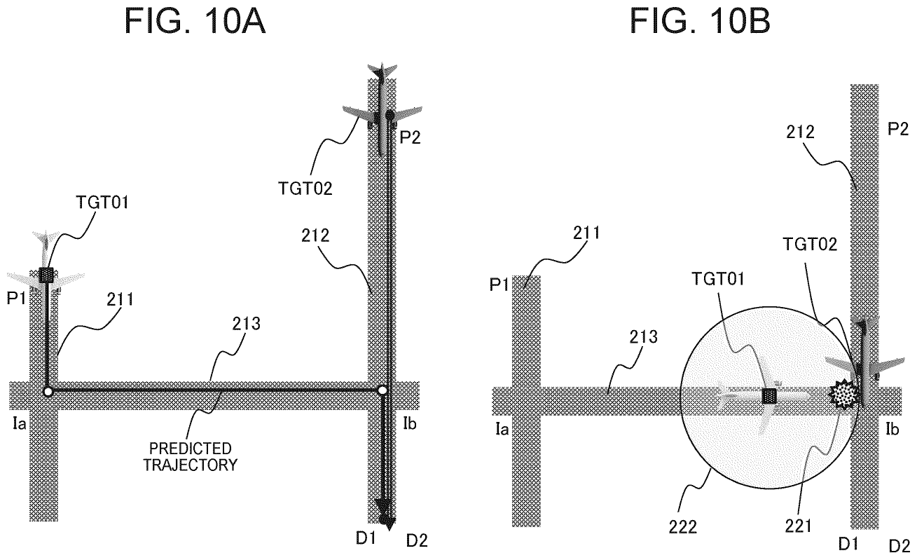

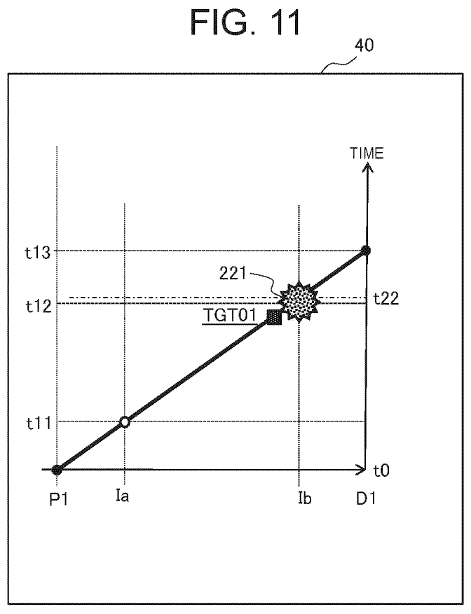

FIG. 10A is a plan view showing the predicted trajectories of the selected aircraft TGT01 and the relevant aircraft TGT02. FIG. 10B is a plan view showing an example of occurrence of the abnormal approach (danger of collision in this example) of the selected aircraft TGT01 and the relevant aircraft TGT02 at an intersection. FIG. 11 is a diagram showing a display example at the time of the occurrence of the abnormal approach in FIG. 10B (danger of collision at the intersection in this example). FIG. 10A shows an example in which the aircraft TGT01 taxis from the start point P1 as the starting position of the taxiing to the end point D1 as the destination by successively passing through the intersections Ia and Ib. Further, FIG. 10A shows an example in which the aircraft TGT02 taxis from a start point P2 as the starting position of the taxiing to an end point D2 as the destination by successively passing through the intersections Ib and Ia. In FIG. 11, the example in which the aircraft TGT01 taxis from the start point P1 as the starting position of the taxiing (time t0) to the end point D1 as the destination by successively passing through the intersections Ia and Ib is shown in the two-dimensional coordinate system as a straight line. As shown in FIG. 11, the display device 40 is made to display the enhanced display component 221 at the position of the aircraft TGT02 relevant to the selected aircraft TGT01 at the time of the occurrence of the abnormal approach. FIG. 11 corresponding to the state of the step S8 in FIG. 3.

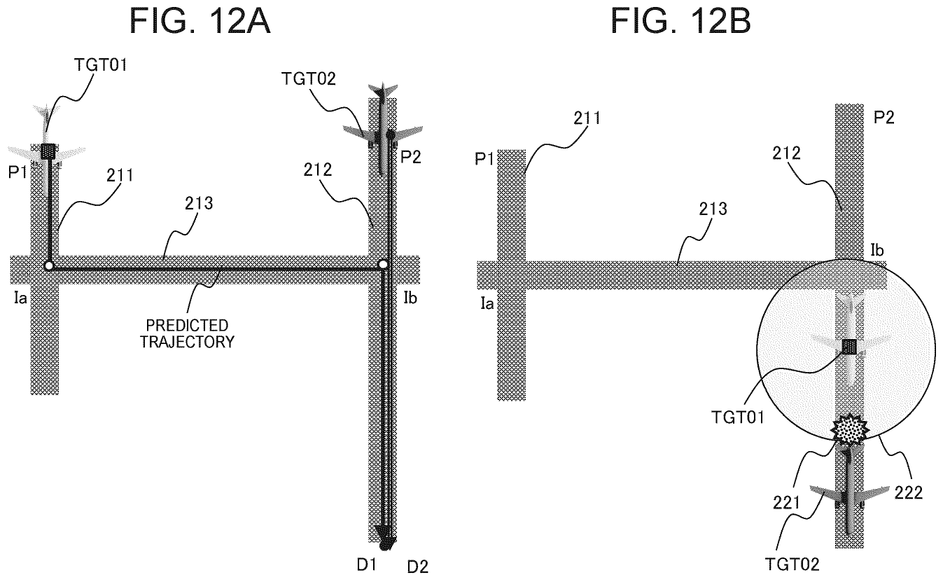

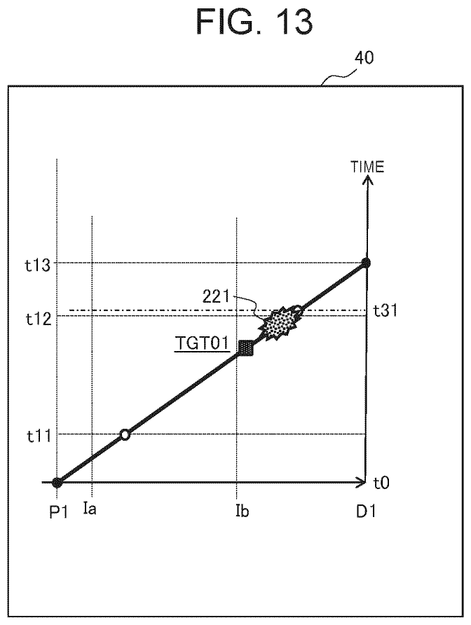

FIG. 12A is a plan view showing the predicted trajectories of the selected aircraft TGT01 and the relevant aircraft TGT02. FIG. 12B is a plan view showing an example of occurrence of the abnormal approach (danger of rear-end collision in this example) of the selected aircraft TGT01 and the relevant aircraft TGT02 on the taxiway 212. FIG. 13 is a diagram showing a display example at the time of the occurrence of the abnormal approach in FIG. 12B (danger of collision at a taxiway in this example). FIG. 12A shows an example in which the aircraft TGT01 taxis from a start point P1 as the starting position of the taxiing to an end point D1 as the destination by successively passing through the intersections Ia and Ib. Further, FIG. 12A shows an example in which the aircraft TGT02 taxis from a start point P2 as the starting position of the taxiing to an end point D2 as the destination by passing through the intersection Ib. In FIG. 13 the example in which the aircraft TGT01 taxis from the start point P1 as the starting position of the taxiing (time t0) to the end point D1 as the destination by successively passing through the intersections Ia and Ib is shown in the two-dimensional coordinate system as a straight line. As shown in FIG. 13, the display device 40 is made to display the enhanced display component 221 at the position of the aircraft TGT02 relevant to the selected aircraft TGT01 at the time of the occurrence of the abnormal approach. FIG. 13 corresponding to the state of the step S8 in FIG. 3.

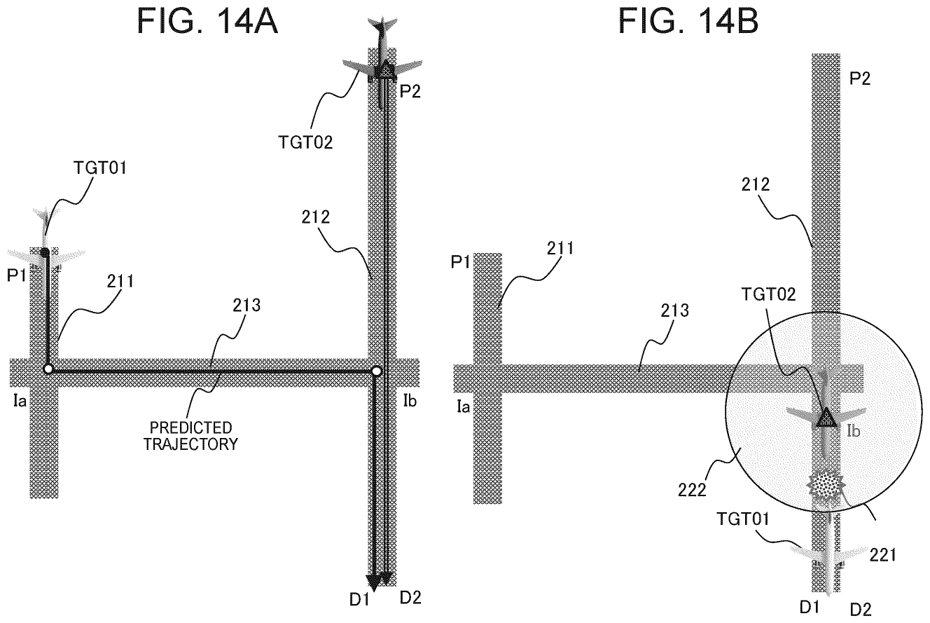

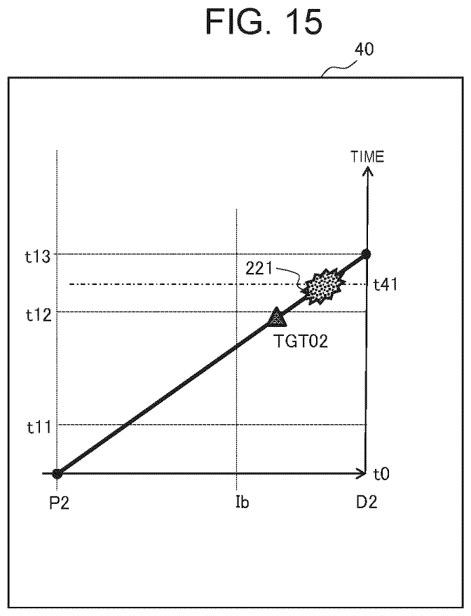

FIG. 14A is a plan view showing the predicted trajectories of a selected aircraft TGT02 and an aircraft TGT01 relevant to the selected aircraft TGT02. FIG. 14B is a plan view showing an example of occurrence of the abnormal approach (danger of rear-end collision in this example) of the selected aircraft TGT02 and the aircraft TGT01 relevant to the selected aircraft TGT02 on the taxiway 212. FIG. 15 is a diagram showing a display example at the time of the occurrence of the abnormal approach in FIG. 14B (danger of rear-end collision in this example). FIG. 14A shows an example in which the aircraft TGT01 taxis from a start point P1 as the starting position of the taxiing to an end point D1 as the destination by successively passing through the intersections Ia and Ib and the aircraft TGT02 taxis from a start point P2 as the starting position of the taxiing to an end point D2 as the destination by traveling forward through the intersection Ib. Further, FIG. 14B shows the example in which the aircraft TGT02 taxis from the start point P2 as the starting position of the taxiing to the end point D2 as the destination via the intersection Ib. In FIG. 15, the example in which the aircraft TGT02 taxis from the start point P2 as the starting position of the taxiing (time t0) to the end point D2 as the destination via the intersection Ib is shown in the two-dimensional coordinate system as a straight line. As shown in FIG. 15, the display device 40 is made to display the enhanced display component 221 at the position of the aircraft TGT01 relevant to the selected aircraft TGT02 at the time of the occurrence of the abnormal approach. FIG. 15 corresponding to the state of the step S8 in FIG. 3.

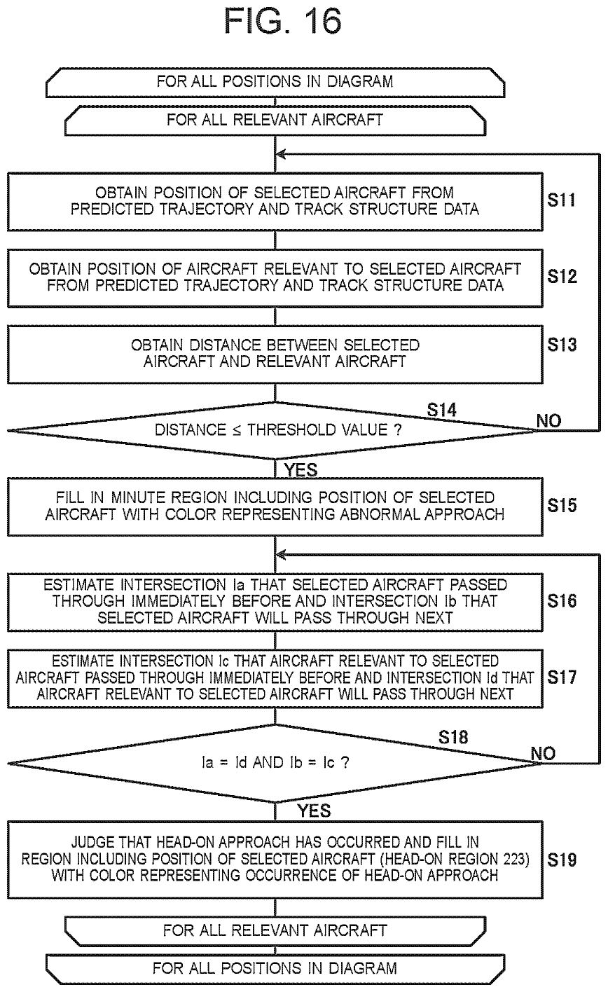

FIG. 16 is a flowchart showing a drawing process of the display control device 10 according to the first embodiment. First, the display control device 10 obtains the position of the selected aircraft from the predicted trajectory of the selected aircraft and the acquired track structure data (step S11). Subsequently, the display control device 10 obtains the position of an aircraft relevant to the selected aircraft from the predicted trajectory of the relevant aircraft and the acquired track structure data (step S12). The steps S11 and S12 may also be executed in reverse order or executed in parallel.

The display control device 10 obtains the distance between the selected aircraft and the aircraft relevant to the selected aircraft (step S13) and judges whether or not the obtained distance is less than or equal to a predetermined reference value (i.e., threshold value) (step S14). If the obtained distance is greater than the predetermined threshold value (NO in the step S14), the process returns to the step S11. If the obtained distance is less than or equal to the predetermined threshold value (YES in the step S14), the process advances to step S15.

In the step S15, the display control device 10 fills in a minute region including the position of the selected aircraft with a color representing the abnormal approach (e.g., danger of collision at an intersection, rear-end collision, or head-on collision). The minute region is a region in predetermined size and shape, for example. The size of the minute region is specified by the number of pixels in each of a vertical direction and a horizontal direction, for example. The shape of the minute region is a quadrangular shape, a circular shape, an elliptical shape, a triangular shape or the like, for example. By the processing of the steps S11 to S15, a color, luminance, a pattern, or a combination of two or more out of these for displaying the abnormal approach may be assigned to one minute region regarding one relevant aircraft.

Subsequently, the display control device 10 estimates an intersection Ia that the selected aircraft passed through immediately before and an intersection Ib that the selected aircraft will pass through next (step S16). Subsequently, the display control device 10 estimates an intersection Ic that the aircraft relevant to the selected aircraft passed through last time and an intersection Id that the aircraft relevant to the selected aircraft will pass through next (step S17). The display control device 10 judges whether or not Ia=Id and Ib=Ic hold (step S18).

If the condition Ia=Id and Ib=Ic is not satisfied (NO in the step S18), the process returns to the step S16. If the condition Ia=Id and Ib=Ic is satisfied (YES in the step S18), the process advances to step S19. In the step S19, the display control device 10 judges that the head-on approach has occurred between the selected aircraft and the aircraft relevant to the selected aircraft and fills in the head-on region with a predetermined color.

The processing of the steps S11 to S19 is executed for all of the relevant aircraft. Further, this process is executed for all positions in the diagram. In other words, one minute region including the position of the abnormal approach is filled in with color by the processing of the steps S11 to S15 in FIG. 16, and one minute region including the position of the head-on approach is filled in with color by the processing of the steps S16 to S19.

As described above, in the first embodiment, the occurrence of the abnormal approach between the selected mobile object and a mobile object relevant to the selected mobile object is displayed by using the predicted trajectory, the enhanced display component 221 and the head-on region 223 (when the head-on approach occurs) in the two-dimensional coordinate system. When the two-dimensional display is used as above, the air traffic controller is facilitated to grasp the occurrence of the abnormal approach, the position of the abnormal approach, and the type (whether it is an intersection, a rear-end, or a head-on) of the abnormal approach.

Further, by simultaneously displaying the presence/absence of the abnormal approach between the selected mobile object and a plurality of relevant mobile objects, it is possible to simultaneously grasp whether the trajectory set for each mobile object is safe or not.

### Second Embodiment

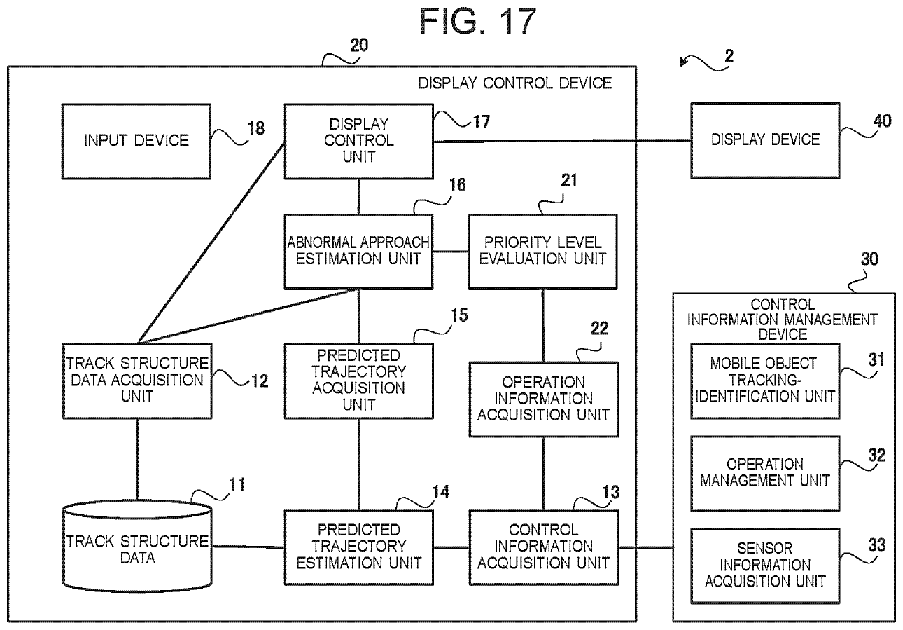

FIG. 17 is a functional block diagram schematically showing the configuration of a display control device 20 and a control system 2 according to a second embodiment. In FIG. 17, each component identical or corresponding to a component shown in FIG. 1 is assigned the same reference character as in FIG. 1. The display control device 20 according to the second embodiment differs from the display control device 10 according to the first embodiment in including a priority level evaluation unit 21 and an operation information acquisition unit 22. The display control device 20 is a device capable of executing a display control method according to the second embodiment. The display control device 20 is, for example, a computer executing a display control program according to the second embodiment.

The priority level evaluation unit 21 evaluates a priority level of an abnormal approach based on the control information. The display control unit 17 increases a level of enhancement of the enhanced display component regarding an abnormal approach at a high priority level in the display mode. The method of increasing the level of enhancement can be, for example, raising the luminance of the enhanced display component, darkening the color of the enhanced display component, increasing the size of the enhanced display component, changing the shape of the enhanced display component to a conspicuous shape such as a star shape, a double circle or the like, changing the color of the enhanced display component to a conspicuous color such as red, periodically changing the color of the enhanced display component, periodically changing the shape of the enhanced display component, increasing blinking speed of the enhanced display component, a combination of two or more out of these methods, or the like.

Further, the priority level evaluation unit 21 may evaluate the priority level of the abnormal approach based on size information regarding the mobile object acquired by the operation information acquisition unit 22. For example, the priority level evaluation unit 21 may assign a higher priority level to the abnormal approach with the increase in the size of the abnormal approach mobile object. This is because a larger mobile object requires a longer braking distance as the distance necessary for stopping.

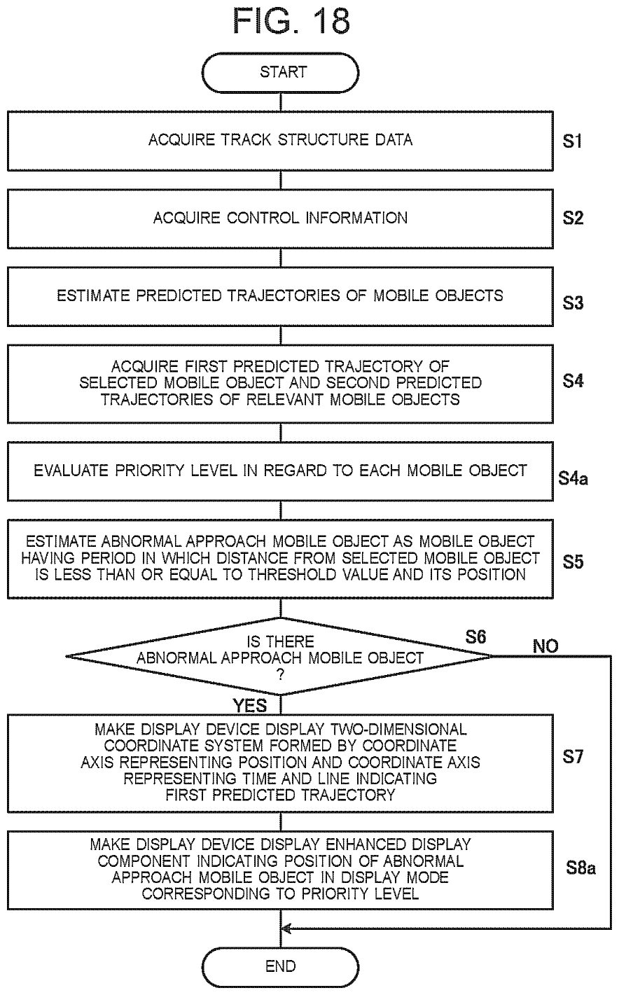

FIG. 18 is a flowchart showing the operation of the display control device 20 according to the second embodiment. In FIG. 18, each step identical or corresponding to a step shown in FIG. 3 is assigned the same reference character as in FIG. 3. As shown in FIG. 18, the display control device 20 according to the second embodiment differs from the display control device 10 according to the first embodiment in having step S4a of evaluating the priority level and in step S4a of making the display device 40 display the enhanced display component (e.g., circle, ellipse, quadrangle, triangle or the like) indicating the position of the abnormal approach mobile object and the head-on region as the enhanced region in a display mode corresponding to the priority level.

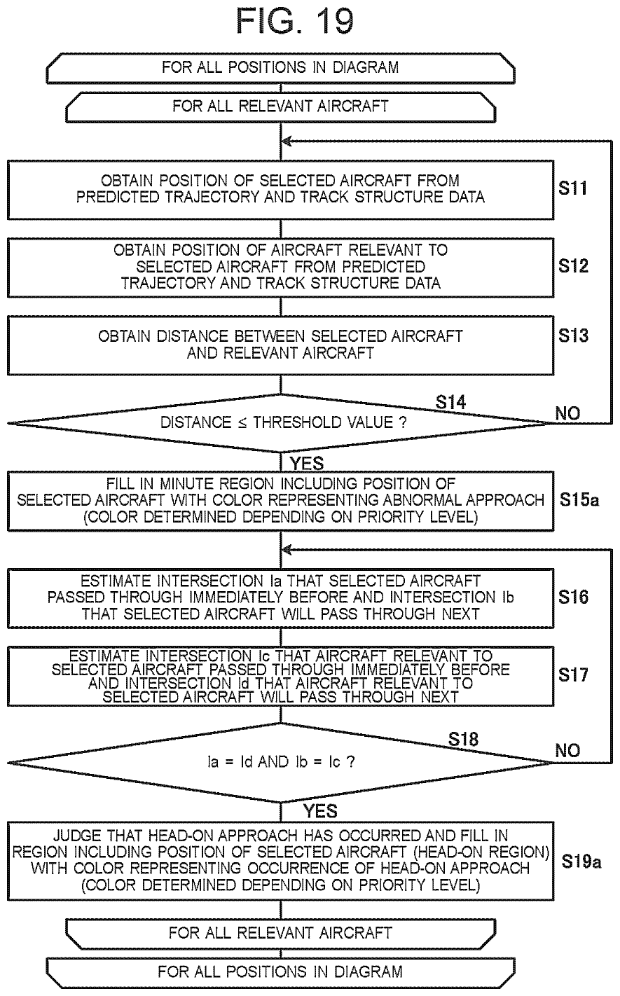

FIG. 19 is a flowchart showing a drawing process of the display control device 20 according to the second embodiment. In FIG. 19, each step identical or corresponding to a step shown in FIG. 16 is assigned the same reference character as in FIG. 16. As shown in FIG. 19, the display control device 20 according to the second embodiment differs from the display control device 10 according to the first embodiment in having step S15a of filling in the enhanced display component as the minute region including the position of the selected aircraft with a color determined depending on the priority level when filling in the enhanced display component with the color representing the abnormal approach and in step S19a of filling in a head-on region 224 as an enhanced region including the minute region including the position of the selected aircraft with a color representing the head-on approach and determined depending on the priority level when it is judged that the head-on approach has occurred.

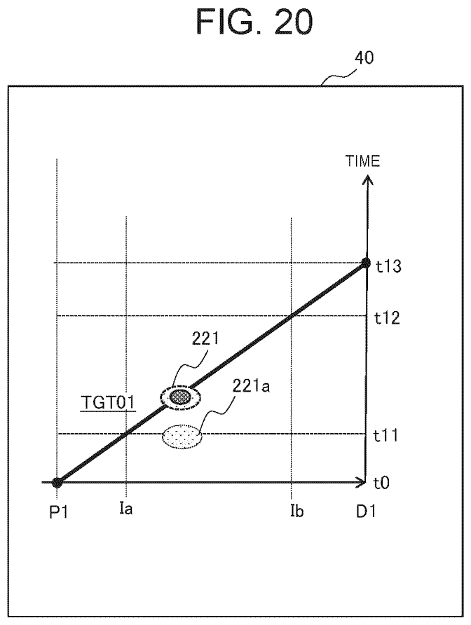

FIG. 20 is a diagram showing a display example of enhanced display components 221 and 221a at the time of the occurrence of the abnormal approach (the step S15a in FIG. 19). In FIG. 20, the enhanced display component 221 like a double circle in a dark color represents an abnormal approach at a high priority level, and the enhanced display component 221a like a circle in a light color represents an abnormal approach at a low priority level.

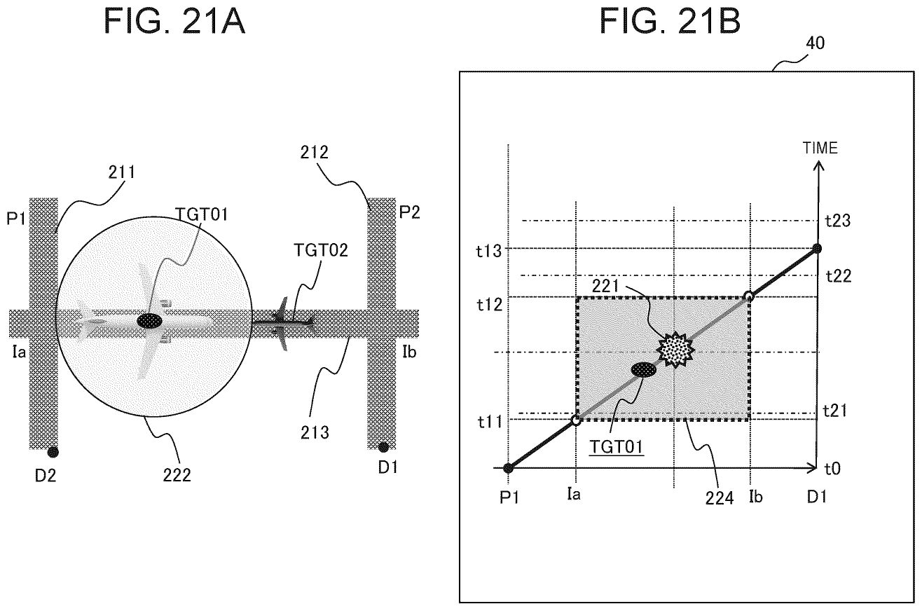

FIG. 21A is a plan view showing an example in which the selected aircraft TGT01 (aircraft at a high priority level) and the aircraft TGT02 relevant to the selected aircraft TGT01 start traveling in the directions of approaching each other on the same taxiway 213. FIG. 21B is a diagram showing a display example of the display device 40 at the time of the occurrence of the situation in FIG. 21A (the step S19a in FIG. 19). As shown in FIG. 21B, when there are two aircraft that start traveling in the directions of approaching each other on the same taxiway 213, the head-on region 224 as a region in which the head-on approach can occur (region including the section between the intersections Ia and Ib in the taxiway 213) is designated as an enhanced region to be displayed in the enhanced display in a display format indicating that the head-on approach can occur and corresponding to the priority level. The method of displaying the enhanced region can be filling in with color, variation in the color, variation in the luminance, variation in the pattern, a combination of some of these methods, or the like.

As described above, in the second embodiment, the occurrence of the abnormal approach between the selected mobile object and a mobile object relevant to the selected mobile object is displayed by using the predicted trajectory, the enhanced display component 221 and the head-on region 224 as the enhanced region in the two-dimensional coordinate system, and a display method corresponding to the priority level of the mobile object is employed as the display method of the enhanced display component 221 and the head-on region 224. When the two-dimensional display is used as above, the air traffic controller is facilitated to grasp the occurrence of the abnormal approach, the position of the abnormal approach, and the type (whether it is an intersection, a rear-end, or a head-on) of the abnormal approach. Further, since the display is changed depending on the priority level, the order of issuance of commands by the air traffic controller can be made appropriate when a plurality of abnormal approaches occur at the same time.

Except for the above-described features, the second embodiment is the same as the first embodiment.

### Third Embodiment

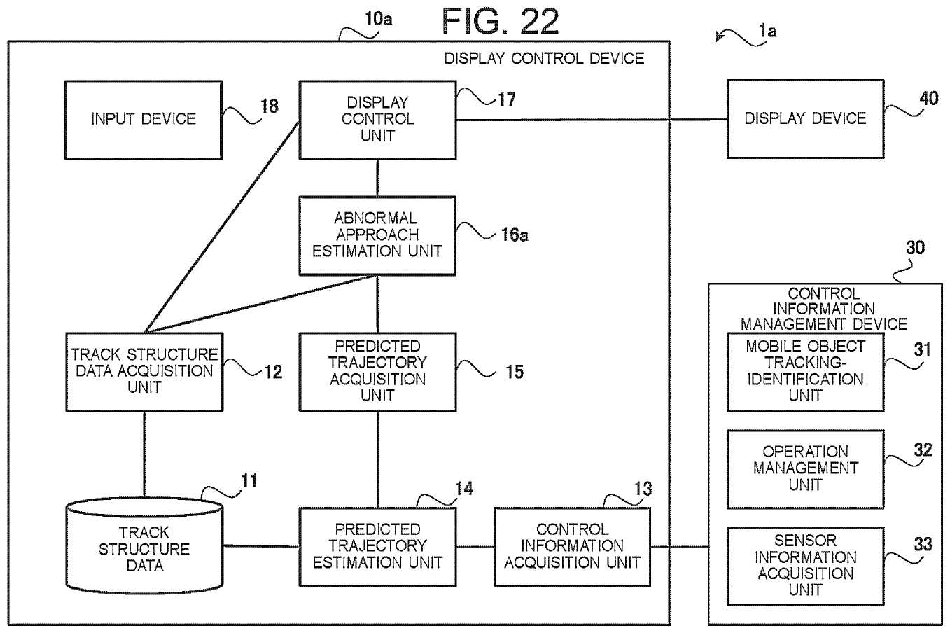

FIG. 22 is a functional block diagram schematically showing the configuration of a display control device 10a and a control system 1a according to a third embodiment. In FIG. 22, each component identical or corresponding to a component shown in FIG. 1 is assigned the same reference character as in FIG. 1. The display control device 10a according to the third embodiment differs from the display control device 10 according to the first embodiment in that an abnormal approach estimation unit 16a handles an abnormal approach between an aircraft 51 traveling on a runway 50 (which can also be an aircraft at the time of takeoff or landing) and an aircraft 61 (DEP001) traveling on a taxiway 60 intersecting with the runway 50. Except for this feature, the display control device 10a according to the third embodiment is the same as the display control device 10 according to the first embodiment.

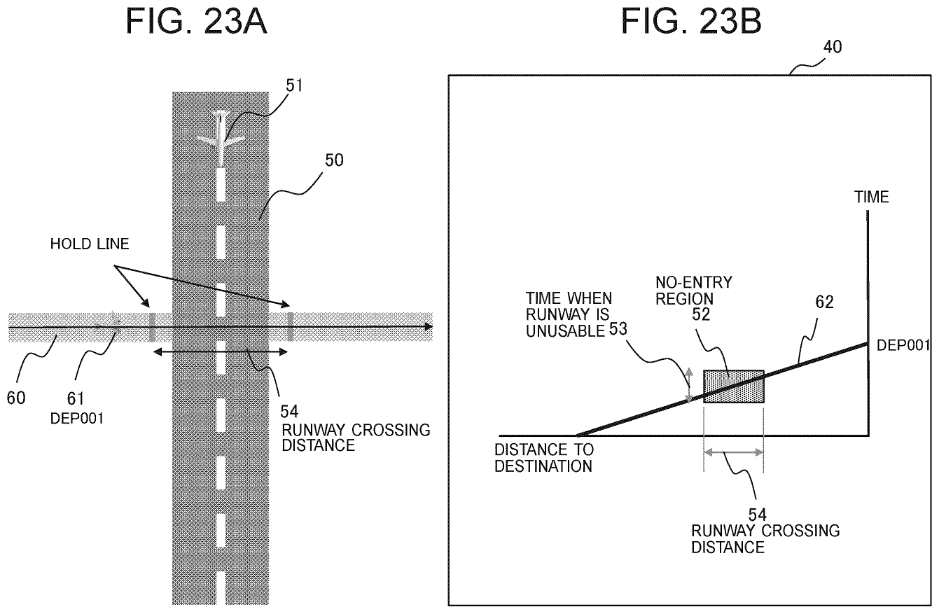

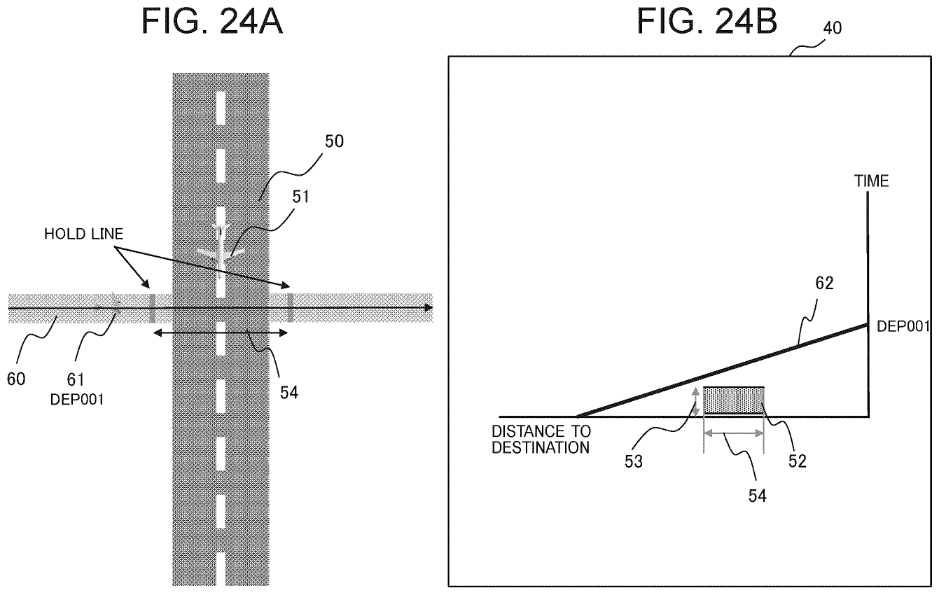

FIG. 23A is a plan view showing an example of a situation immediately before the selected aircraft 61 crosses the runway 50 (namely, a case where there is a no-entry region 52 in front), and FIG. 23B is a diagram showing a display example of the display device 40 at the time of the occurrence of the situation in FIG. 23A. Further, FIG. 24A is a plan view showing an example of a situation immediately before the selected aircraft 61 crosses the runway 50 (namely, a case where there is not the no-entry region 52 in front), and FIG. 24B is a diagram showing a display example of the display device 40 at the time of the occurrence of the situation in FIG. 24A. The abnormal approach estimation unit 16a of the display control device 10a handles the case where the abnormal approach mobile object is the aircraft 51 traveling on the runway 50 (which can also be an aircraft at the time of takeoff or landing) and the mobile object as the monitoring target is the aircraft 61 (DEP001) traveling on the taxiway 60 intersecting with the runway 50, and the display control unit 17 handles the predicted trajectory of the aircraft 61 traveling on the taxiway 60 and the no-entry region (referred to also as a “cross-runway prohibition region”) 52 due to the aircraft 51 traveling on the runway 50. Specifically, in the third embodiment, in the case where the abnormal approach mobile object can also be an aircraft at the time of takeoff or landing traveling on a runway as a track and the mobile object selected as the monitoring target is an aircraft or a vehicle traveling on a taxiway intersecting with the runway, the display control device 10a estimates the predicted trajectory regarding the mobile object selected as the monitoring target (indicated by a line 62) and the no-entry region 52 indicating the time when the aircraft as the abnormal approach mobile object passes through an intersection region of the runway and the taxiway and a crossing distance of the runway. Further, the display control unit 17 makes the display device display the line 62 indicating the predicted trajectory regarding the mobile object selected as the monitoring target and a figure representing the no-entry region 52 on a two-dimensional coordinate system formed by a coordinate axis representing the position (e.g., distance to the destination) and a coordinate axis representing the time. Except for these features, the display control device 10a according to the third embodiment is the same as the display control device 10 according to the first embodiment.

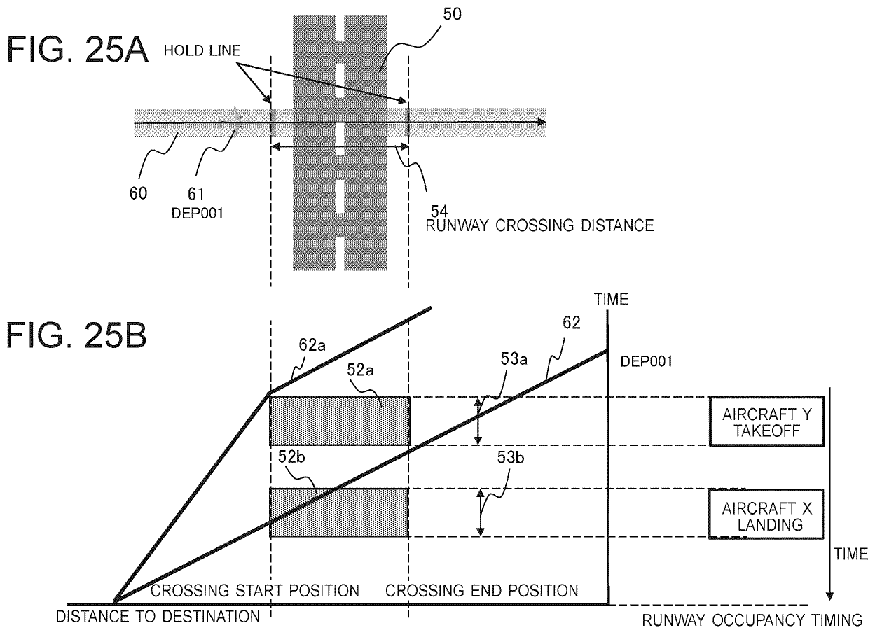

FIG. 25A is a plan view showing an example of a situation immediately before the selected aircraft 61 crosses the runway 50, and FIG. 25B is a diagram showing a display example of the display device 40 at the time of the occurrence of the situation in FIG. 25A. In this example, there occur landing of an aircraft X and takeoff of an aircraft Y on the runway 50 between a start point (starting position) and an end point (destination) of the predicted trajectory of the selected aircraft 61 (indicated by the line 62) and there exist a no-entry region 52b (no-entry time 53b) due to the aircraft X and a no-entry region 52a (no-entry time 53a) due to the aircraft Y. In this example, it is necessary to make correction of a trajectory like the predicted trajectory (indicated by a line 62a), for example.

As described above, in the third embodiment, the occurrence of the abnormal approach between the selected mobile object and a mobile object relevant to the selected mobile object is displayed by using the predicted trajectory and the no-entry region 52 as the enhanced display component in the two-dimensional coordinate system. When the two-dimensional display is used as above, the air traffic controller is facilitated to grasp the occurrence of the abnormal approach, the position of the abnormal approach, and the type (whether it is an intersection, a rear-end, or a head-on) of the abnormal approach.

Incidentally, it is also possible to apply the abnormal approach estimation unit 16a in the third embodiment to the second embodiment.

### Fourth Embodiment

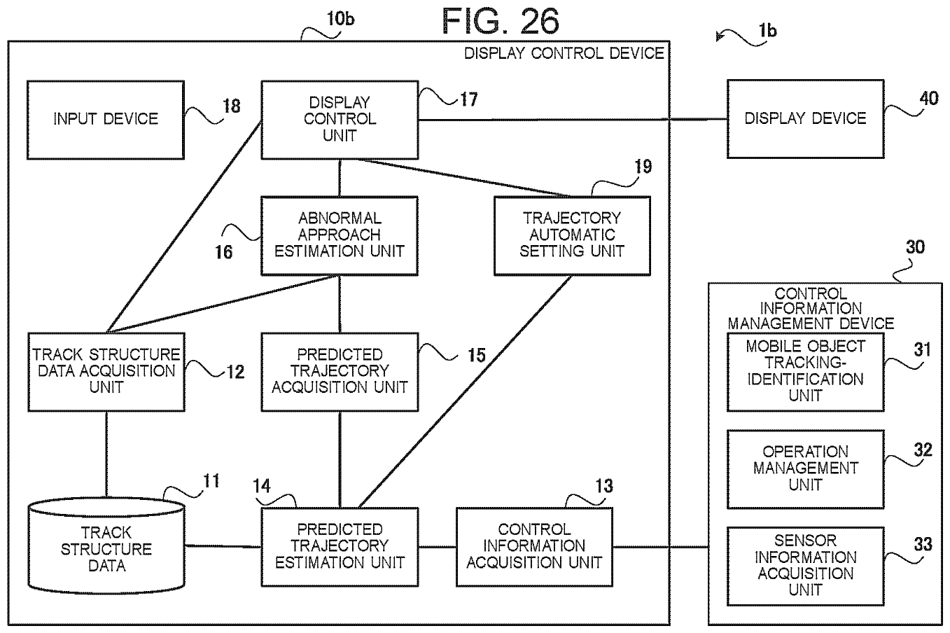

FIG. 26 is a functional block diagram schematically showing the configuration of a display control device 10b and a control system 1b according to a fourth embodiment. In FIG. 26, each component identical or corresponding to a component shown in FIG. 1 is assigned the same reference character as in FIG. 1. The display control device 10b according to the fourth embodiment differs from the display control device 10 according to the first embodiment in including a trajectory automatic setting unit 19.

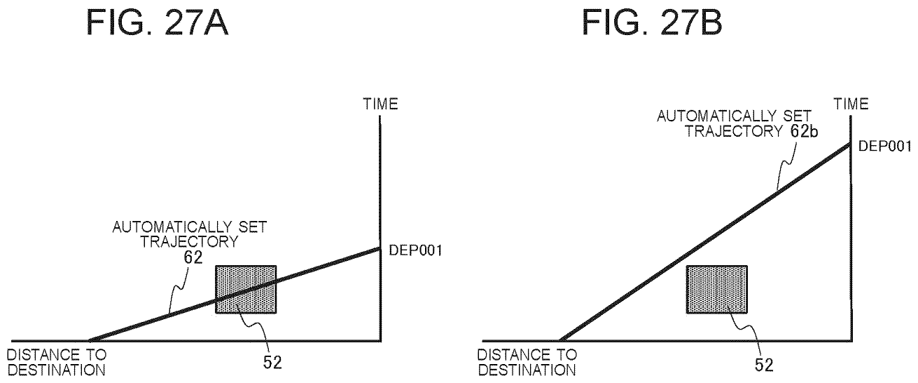

FIG. 27A is a diagram showing an example in which the selected aircraft crosses a runway (namely, a case where there is the no-entry region 52 in front). FIG. 27B is a diagram showing the operation of the trajectory automatic setting unit at the time of the occurrence of the situation in FIG. 27A. When the predicted trajectory (i.e., the line 62) includes a part overlapping with the no-entry region 52 as shown in FIG. 27A, the trajectory automatic setting unit 19 automatically changes a travel schedule of the selected mobile object so that the predicted trajectory (i.e., the line 62) does not overlap with the no-entry region as shown in FIG. 27B. Except for this feature, the display control device 10b according to the fourth embodiment is the same as the display control device 10 according to the first embodiment.

As described above, in the fourth embodiment, the occurrence of the abnormal approach between the selected mobile object and a mobile object relevant to the selected mobile object is displayed by using the predicted trajectory and the no-entry region 52 as the enhanced display component in the two-dimensional coordinate system. When the two-dimensional display is used as above, the air traffic controller is facilitated to grasp the occurrence of the abnormal approach, the position of the abnormal approach, and the type (whether it is an intersection, a rear-end, or a head-on), of the abnormal approach. Further, the predicted trajectory can be changed automatically and it is possible to check the corrected predicted trajectory on a screen using the two-dimensional display that is easy to grasp.

Incidentally, it is also possible to apply the trajectory automatic setting unit 19 in the fourth embodiment to any one of the first to third embodiments.

### DESCRIPTION OF REFERENCE CHARACTERS

1, 1a, 1b, 2: control system, 10, 10a, 10b, 20: display control device, 11: storage device, 12: track structure data acquisition unit, 13: control information acquisition unit, 14: predicted trajectory estimation unit, 15: predicted trajectory acquisition unit, 16: abnormal approach estimation unit, 17: display control unit, 19: trajectory automatic setting unit, 21: priority level evaluation unit, 22: operation information acquisition unit, 30: control information management device (management device), 40: display device, 221, 221a: enhanced display component, 223, 224: head-on region (enhanced region).

What is claimed is:

1. A display control device in a control system for transmitting commands to a plurality of mobile objects traveling on a plurality of tracks, the display control device comprising processing circuitry:
to acquire track structure data indicating structure of the plurality of tracks;
to acquire control information from a management device that manages the control information including positions and operation schedules of the plurality of mobile objects;
to estimate predicted trajectories indicating travel routes of the plurality of mobile objects based on the track structure data and the control information;
to acquire a first predicted trajectory indicating a travel route of a mobile object selected as a monitoring target among the plurality of mobile objects and a plurality of second predicted trajectories indicating travel routes of a plurality of relevant mobile objects being mobile objects other than the selected mobile object from the predicted trajectories;
to estimate an abnormal approach mobile object as a mobile object having a period in which a distance from the selected mobile object is less than or equal to a predetermined reference value out of the plurality of relevant mobile objects and to estimate the position of the abnormal approach mobile object in the abnormal approach period based on the track structure data, the first predicted trajectory, and the plurality of second predicted trajectories; and
to make a display device display a two-dimensional coordinate system formed by a first coordinate axis representing positions from a start point to an end point of the first predicted trajectory by distances from the start point and a second coordinate axis representing a time and a line indicating the first predicted trajectory in the two-dimensional coordinate system and to make the display device display an enhanced display component that indicates the position of the abnormal approach mobile object in the abnormal approach period in the two-dimensional coordinate system.

2. The display control device according to claim 1, wherein the processing circuitry acquires information regarding a visibility range in atmospheric air at the plurality of tracks from the management device and increases the reference value with a decrease in the visibility range.

3. The display control device according to claim 1, wherein the processing circuitry acquires information regarding a wind direction and a wind speed at the plurality of tracks from the management device and increases the reference value when the wind direction is a following wind direction with an increase in the wind speed.

4. The display control device according to claim 1, wherein the processing circuitry acquires size of the selected mobile object from the management device and increases the reference value with an increase in the size of the selected mobile object.

5. The display control device according to claim 1, further comprising a storage device to store the track structure data.

6. The display control device according to claim 1, wherein the abnormal approach includes approach between the selected mobile object traveling on a first track and the relevant mobile object traveling on a second track at a distance within the reference value at an intersection of the first track and the second track intersecting with each other among the plurality of tracks.

7. The display control device according to claim 6, wherein the processing circuitry has the enhanced display component displayed at coordinates determined by a position of occurrence of the abnormal approach and a time of the occurrence of the abnormal approach.

8. The display control device according to claim 1, wherein the abnormal approach includes approach between the selected mobile object and the abnormal approach mobile object traveling in a same direction on one track among the plurality of tracks at a distance within the reference value.

9. The display control device according to claim 8, wherein the processing circuitry has the enhanced display component displayed at coordinates or in a region determined by a position of occurrence of the abnormal approach and a time of the occurrence of the abnormal approach.

10. The display control device according to claim 1, wherein the abnormal approach includes approach between the selected mobile object and the abnormal approach mobile object at a distance within the reference value upon occurrence of head-on approach in which the two mobile objects travel in directions of approaching each other on one track among the plurality of tracks.

11. The display control device according to claim 10, wherein the processing circuitry
has the enhanced display component displayed at coordinates or in a region determined by a position of occurrence of the abnormal approach and a time of the occurrence of the abnormal approach, and
displays the one track on which the two mobile objects travel in directions of approaching each other in enhanced display as a head-on region.

12. The display control device according to claim 1, wherein
the processing circuitry evaluates a priority level of the abnormal approach based on the control information, and increases a level of enhancement of the enhanced display component regarding an abnormal approach at a high priority level in a display mode.

13. The display control device according to claim 12, wherein the processing circuitry assigns a higher priority level as the priority level with an increase in size of the abnormal approach mobile object.

14. The display control device according to claim 1, wherein
the plurality of mobile objects include an aircraft, a vehicle, or both of an aircraft and a vehicle, and
the plurality of tracks include a taxiway and a runway in an airport.

15. The display control device according to claim 1, wherein
when the abnormal approach mobile object is an aircraft traveling on a runway as the track and the selected mobile object travels on a taxiway intersecting with the runway, the processing circuitry estimates the first predicted trajectory regarding the selected mobile object and a no-entry region indicating a time when the aircraft as the abnormal approach mobile object passes through an intersection region of the runway and the taxiway and a crossing distance of the runway, and
the processing circuitry has a line indicating the first predicted trajectory regarding the selected mobile object and a figure representing the no-entry region displayed on the two-dimensional coordinate system.

16. The display control device according to claim 15, wherein the abnormal approach mobile object is the aircraft landing and traveling on the runway or the aircraft traveling on the runway and taking off.

17. The display control device according to claim 15, wherein the processing circuitry changes a travel schedule of the selected mobile object so that the first predicted trajectory does not overlap with the no-entry region when the first predicted trajectory includes a part overlapping with the no-entry region.

18. A display control method to be executed by a display control device in a control system for transmitting commands to a plurality of mobile objects traveling on a plurality of tracks, the display control method comprising:
acquiring track structure data indicating structure of the plurality of tracks;
acquiring control information from a management device that manages the control information including positions and operation schedules of the plurality of mobile objects;
estimating predicted trajectories indicating travel routes of the plurality of mobile objects based on the track structure data and the control information;
acquiring a first predicted trajectory indicating a travel route of a mobile object selected as a monitoring target among the plurality of mobile objects and a plurality of second predicted trajectories indicating travel routes of a plurality of relevant mobile objects being mobile objects other than the selected mobile object from the predicted trajectories;
estimating an abnormal approach mobile object as a mobile object having a period in which a distance from the selected mobile object is less than or equal to a predetermined reference value out of the plurality of relevant mobile objects and estimating the position of the abnormal approach mobile object in the abnormal approach period based on the track structure data, the first predicted trajectory, and the plurality of second predicted trajectories; and
making a display device display a two-dimensional coordinate system formed by a first coordinate axis representing positions from a start point to an end point of the first predicted trajectory by distances from the start point and a second coordinate axis representing a time and a line indicating the first predicted trajectory in the two-dimensional coordinate system and making the display device display an enhanced display component that indicates the position of the abnormal approach mobile object in the abnormal approach period in the two-dimensional coordinate system.

19. A non-transitory computer-readable storage medium for storing a display control program that causes a display control device in a control system for transmitting commands to a plurality of mobile objects traveling on a plurality of tracks to execute processes of:
acquiring track structure data indicating structure of the plurality of tracks;
acquiring control information from a management device that manages the control information including positions and operation schedules of the plurality of mobile objects;
estimating predicted trajectories indicating travel routes of the plurality of mobile objects based on the track structure data and the control information;
acquiring a first predicted trajectory indicating a travel route of a mobile object selected as a monitoring target among the plurality of mobile objects and a plurality of second predicted trajectories indicating travel routes of a plurality of relevant mobile objects being mobile objects other than the selected mobile object from the predicted trajectories;
estimating an abnormal approach mobile object as a mobile object having a period in which a distance from the selected mobile object is less than or equal to a predetermined reference value out of the plurality of relevant mobile objects and estimating the position of the abnormal approach mobile object in the abnormal approach period based on the track structure data, the first predicted trajectory, and the plurality of second predicted trajectories; and
making a display device display a two-dimensional coordinate system formed by a first coordinate axis representing positions from a start point to an end point of the first predicted trajectory by distances from the start point and a second coordinate axis representing a time and a line indicating the first predicted trajectory in the two-dimensional coordinate system and making the display device display an enhanced display component that indicates the position of the abnormal approach mobile object in the abnormal approach period in the two-dimensional coordinate system.
